(19) United States
(12) Patent Application Publication
(10) Pub. No.: US 2009/0247677 A1
(43) Pub. Date: Oct. 1, 2009

(54) METHOD FOR PRODUCING LOW VISCOSITY NATURAL RUBBER AND NATURAL RUBBER AND RUBBER COMPOSITION CONTAINING THE SAME

(75) Inventors: Tetsuji Kawazura, Kanagawa (JP); Takashi Kakubo, Kanagawa (JP)

Correspondence Address: CONNOLLY BOVE LODGE & HUTZ LLP, 1875 EYE STREET, N.W., SUITE 1100, WASHINGTON, DC, 20006, US

(73) Assignee: The Yokohama Rubber Co., Ltd., Tokyo (JP)

(21) Appl. No.: 12/091,312

(22) PCT Filed: Oct. 5, 2006
(86) PCT No.: PCT/JP2006/320350

§ 371 Date: May 30, 2008

(30) Foreign Application Priority Data
Oct. 27, 2005 (JP) 2005-312994
Aug. 24, 2006 (JP) 2006-228149

(51) Int. Cl. C08K 5/43; C08C 19/22; C08K 5/41; C08K 5/16; C08K 5/36; C08K 5/08

(52) U.S. Cl. 524/156; 525/333.1; 524/186; 524/211; 524/358; 524/169

(57) ABSTRACT

A production method of a low viscosity or low constant viscosity natural rubber obtained by treating a natural rubber latex by adding a water-soluble ammonium salt so as to decrease the metal content and spraying the treated natural rubber latex or the latex after addition of a constant viscosity agent into a pulse wave atmosphere for pulse drying to obtain solid rubber, a natural rubber obtained by the same, and a rubber composition including the same, whereby a low viscosity or low constant viscosity natural rubber having superior mechanical properties and low viscosity or low constant viscosity and superior processability, a natural rubber obtained by the same and a rubber composition containing the same were provided.

### TECHNICAL FIELD

The present invention relates to a method for producing a low viscosity or low constant viscosity natural rubber and the low viscosity or low constant viscosity rubber obtained by the method and a rubber composition containing the same. More particularly, it relates to a method for producing a low viscosity or low constant viscosity natural rubber decreasing the metal content of the natural rubber latex using a pulse combustion drying method to obtain the solid rubber and a low viscosity or low constant viscosity natural rubber obtained by the method and a rubber composition containing the same.

### BACKGROUND ART

Natural rubber is a resource not depending upon petroleum and has superior mechanical properties, and therefore is increasing the importance thereof. At the present, natural rubber on the market for the production of rubber products includes (1) latex grade technical specified rubber (TSR) produced mainly in the Southeast Asian countries, China and some countries in Africa by tapping the trunks of the rubber trees (scientific name: Hevea Brasiliensis) to harvest latex, coagulating the same with acid, then wringing out the moisture, cutting the resultant rubber into fine pieces, then drying with hot air; (2) general grade TSR produced by collecting harvested latex coagulated with acid or naturally coagulated as a raw material, cutting the same into fine pieces, repeatedly washing it to remove the foreign matter mixed in, then drying the resultant rubber with hot air by a drier; and (3) ribbed smoked sheet (RSS) produced by coagulating harvested latex with acid, etc., rolling the same into a sheet by a ribbed roll and drying the same under natural air, drying this by smoking, and further removing the foreign materials visually. As compared with the method for directly producing solid rubber from latex in natural rubber factories, TSR or RSS, which is produced from a coagulated latex brought into to the natural rubber factories, has a problem that, even with tremendous time and labor expended for removal, the foreign materials are not sufficiently removed. Further, since heat is used for the drying, the oxidation degradation of the rubber occurs, and therefore, this is not preferable. On the other hand, the latex grade TSR produced by direct coagulation of latex, while there is little chance of inclusion of foreign materials, still has the above mentioned problem in drying, and therefore, again the problem of oxidation degradation of rubber is not solved.

As one attempt to solve the above problem, Japanese Patent Publication (A) No. 2005-194503 proposes to use a pulse wave generated by pulse combustion to instantaneously dry the natural rubber latex directly at a low temperature, without coagulation. Further, the inventors engaged in in-depth studies and, as a result, found that by not only directly drying a natural rubber latex, but also subjecting to a certain chemically treatment in the latex state, it is possible to lower the viscosity and to produce natural rubber, which is remarkably easy to process.

### DISCLOSURE OF THE INVENTION

Accordingly, an object of the present invention is to produce a low viscosity natural rubber useful as various types of rubber products such as a tire, belt conveyor, rubber bearing, having a superior productivity, superior mechanical properties, low viscosity and superior processability.

An object of the present invention is to produce a low constant viscosity natural rubber prevented from storage hardening after storage of the dried low viscosity natural rubber, suitable for use for various types of rubber products, superior in productivity, and superior in mechanical properties.

In accordance with the present invention, there is provided a method for producing a low viscosity natural rubber comprising the steps of:

treating a natural rubber latex with a water-soluble ammonium salt to decrease a metal content in the natural rubber and

spraying the treated natural rubber latex in a pulse C wave atmosphere for drying to obtain the solid rubber and the low viscosity natural rubber obtained therefrom and a rubber composition containing the same.

In accordance with the present invention, there is provided a method for producing a low viscosity natural rubber wherein a constant viscosity agent is added, in advance, into the natural rubber latex to be dried by spraying into a pulse wave atmosphere.

According to the present invention, by treating a natural rubber latex by adding a water-soluble ammonium salt such as diammonium hydrogen phosphate, it is possible to remove the metal content in the natural rubber latex as a metal salt, whereby the metal content is decreased in the natural rubber latex, by using the pulse drying method, in which the natural rubber latex is sprayed into a pulse wave atmosphere, to obtain solid rubber, it is possible to obtain a natural rubber having superior mechanical properties, low viscosity, and easy processability, and by adding a low constant viscosity agent to the natural rubber latex in the pulse drying, it is possible to suppress storage hardening during storage of the resultant natural rubber.

### BEST MODE FOR WORKING THE INVENTION

In this specification and in the claims which follow, the singular forms “a”, “an” and “the” include plural referents unless the context clearly dictates otherwise.

The inventors intensively engaged in research to solve the above problem and, as a result, found that by treating a natural rubber latex by adding a water-soluble ammonium salt (e.g., diammonium hydrogen phosphate, ammonium sulfate, monoammonium hydrogen phosphate), it is possible to decrease the metal content in the natural rubber latex, by using the pulse drying method to obtain solid rubber, it is possible to obtain a low viscosity natural rubber having superior mechanical properties, low viscosity, and easy processability, and by adding a low constant viscosity agent to the natural rubber latex in the pulse drying, it is possible to suppress storage hardening during storage of the resultant natural rubber.

According to the present invention, sap is harvested from rubber trees by tapping and then filtered. A water soluble ammonium salt (for example, ammonium hydrogen phosphate, ammonium sulfate, etc.) is added to the latex thus obtained and treated by stirring at 10 to 50° C. for 2 to 24 hours so as to reduce the metal content such as potassium and magnesium in the natural rubber latex, preferably to reduce the content of magnesium to 0.02% by weight or less, preferably 0.010% by weight or less, based upon the dried latex weight. The addition amount of water-soluble ammonium salt is not particularly limited, but 0.2 to 10% by weight based upon the solid content weight of the latex is preferable. If less than 0.2% by weight, more preferably 0.2-5% by weight, the metal content is liable to be insufficiently removed. Even if using an amount more than 10% by weight, a further effect for decreasing the metal content cannot be obtained.

According to the present invention, a natural rubber latex having a decreased metal content is dried by spraying in a pulse atmosphere. The pulse drying method dries the above natural rubber latex to produce rubber, using a pulse burner generating a pulse shock wave as set forth in, for example, Japanese Patent Publication (A) No. 7-71875 etc. In the present invention, such a pulse burner is used to spray dry a natural rubber latex having a solid content concentration of preferably 70% by weight or less in a drying chamber under conditions of preferably a frequency of 250 to 1200 Hz, more preferably 300 to 1000 Hz, and preferably a temperature of 140° C. or less, more preferably 40 to 100° C.

Natural rubber is generally known to increase the viscosity thereof along with time. Therefore, in the past, sometimes a constant viscosity agent is introduced into a natural rubber to suppress the increase in the viscosity of the natural rubber. In a preferable embodiment of the present invention, a constant viscosity agent is added into the natural rubber latex to be dried by spraying in an atmosphere of a shock wave produced by a pulse combustion.

As the constant viscosity agent usable in the present invention, it is possible to use any constant viscosity agent generally used in the past, which is not liable to decompose under the above pulse drying conditions. Specifically, at least one agent of hydroxylamines such as, hydroxylamine sulfate ((NH₂OH)₂.H₂SO₄), hydroxylamine chloride, hydroxylamine, semicarbazide, dimedone, hydrazide compounds such as acetohydrazide, hydrazide propionate, hydrazide butyrate, hydrazide laurate, hydrazide palmitate, hydrazide stearate, hydrazide benzoate, hydrazide laurate, hydrazide phthalate, etc. may be used. These constant viscosity agents are added in amounts, based upon 100 parts by weight of the solid content in the raw natural rubber latex (i.e., dried rubber content), if necessary, of 0.001 part by weight or more, preferably 0.01 to 3 parts by weight. If the amount of the constant viscosity agent is too small, the effect of constant viscosity is liable to become insufficient.

The rubber composition according to the present invention may contain therein, in addition to the low viscosity natural rubber produced by the present method, general diene-based rubber, a reinforcing agent (or filler) such as carbon black, silica, a vulcanization or cross-linking agent, a vulcanization or cross-linking accelerator, various types of oil, an antioxidant, a plasticizer, or other various additives generally compounded into tire use and other rubber compositions. These additives may be compounded by a general method to obtain a composition and to be used for vulcanization or cross-linking. The amounts of these additives may be made conventional general amounts so long as not adversely affecting the object of the present invention.

### EXAMPLES

Examples will now be used to further explain the present invention, but the present invention is not limited to these examples needless to say.

### Examples 1 to 3 and Comparative Examples 1 to 6

### Preparation Example 1

### Production Method of Natural Rubber Used in Example 1

(1) Treatment of Latex

Untreated field latex (made in Thailand, ammonia concentration=1.0% by weight, solid content concentration=about 30% by weight) was gently stirred (25 at 37° C. for 10 hours with the addition of 0.5% by weight of ammonium hydrogen phosphate (1.67% by weight based upon the dried latex weight). This was allowed to stand for a while and then the resultant precipitate was removed and the remainder was centrifugally separated by a centrifugal separator at 12000 rpm for 30 minutes. The resultant cream-like substance was dispersed in distilled water to a solid content concentration of about 60% by weight with the addition of about 0.1% by weight of a surfactant (sodium dodecyl sulfate).

(2) Drying of Latex

The treated latex obtained above was dried using a pulse shock wave dryer (Hypalcon made by Paltec) under conditions of a frequency of 1000 Hz and a temperature of 60° C.

### Preparation Example 2

### Production Method of Natural Rubber Used in Example 2

(1) Treatment of Latex

The treatment was performed by a method similar to Preparation Example 1, except that the amount of addition of ammonium hydrogen phosphate was 1.0% by weight (1.67% by weight, based upon the dried latex weight).

(2) Drying of Latex

Performed by a method similar to Preparation Example 1.

### Preparation Example 3

### Production Method of Natural Rubber Used in Example 3

(1) Treatment of Latex

The treatment was performed by a method similar to Preparation Example 1 except that the amount of addition of ammonium hydrogen phosphate was 3.0% by weight (10% by weight based upon the dried latex weight).

(2) Drying of Latex

Performed by a method similar to Preparation Example 1.

### Comparative Examples 1 to 3

Commercially available products were used.

### Comparative Example 4

Untreated field latex (made in Thailand, ammonia concentration=1.0% by weight, solid content concentration=about 30% by weight) was dried in a gear oven at 90° C. for 3 hours.

### Comparative Example 5

Untreated field latex (made in Thailand, ammonia concentration=1.0% by weight, solid content concentration=about 30% by weight) was centrifugally separated by a centrifugal separator at 12000 rpm for 30 minutes. The resultant cream-like substance was dispersed in distilled water, with the addition of about 0.1% by weight of a surfactant (sodium dodecyl sulfate), to a solid content concentration of about 60%. The drying was performed in the same way as Example 1.

### Comparative Example 6

Latex treated in the same way as Preparation Example 1 was dried by the same method as in Comparative Example 4.

The metal contents of the natural rubbers obtained were first measured by induction plasma spectroscopy after first decomposition of the natural rubber by a wet-type ashing apparatus. The results are shown in Table I.

TABLE I

| | | | | | | Comp. | Comp. | Comp. | | | |
|---|---|---|---|---|---|---|---|---|---|---|---|
| | | | | | | Ex. 4 | Ex. 5 | Ex. 6 | Ex. 1 | Ex. 2 | Ex. 3 |
| | | | | | | Ordinary latex | | Treated latex | | | |
| | | | Comp. | Comp. | Comp. | | Pulse | | Pulse | Pulse | Pulse |
| | | | Ex. 1 | Ex. 2 | Ex. 3 | Oven | combustion | Oven | combustion | combustion | combustion |
| | | | RSS#3 | SMR-L | STR20 | drying | drying | drying | drying | drying | drying |
| Content | Na | w % | 0.110 | 0.187 | 0.043 | 0.039 | 0.025 | 0.021 | 0.005 | 0.033 | 0.003 |
| of metal | K | w % | 0.064 | 0.089 | 0.296 | 0.320 | 0.512 | 0.043 | 0.199 | 0.074 | 0.177 |
| elements | Mg | w % | 0.130 | 0.065 | 0.052 | 0.056 | 0.025 | 0.001> | 0.001> | 0.001> | 0.001> |
| | P | w % | 0.799 | 0.820 | 0.088 | 0.084 | 0.085 | 0.121 | 0.245 | 0.123 | 0.232 |
| | Ca | w % | 0.031 | 0.022 | 0.012 | 0.014 | 0.011 | 0.010 | 0.007 | 0.009 | 0.004 |
| | Mn | w % | 0.001> | 0.001> | 0.001> | 0.001> | 0.001> | ND | ND | ND | ND |
| | Fe | w % | 0.062 | 0.024 | 0.005 | 0.009 | 0.005 | 0.004 | 0.038 | 0.004 | 0.003 |
| | Cu | w % | ND | ND | ND | ND | ND | ND | ND | ND | ND |
| | Zn | w % | ND | ND | ND | ND | 0.016 | ND | 0.001 | 0.001> | ND |
| Physical properties | | | | | | | | | | | |
| of formulation | | | | | | | | | | | |
| Viscosity | 10 | KPa | 51.9 | 24.8 | 45.1 | 58.1 | 58.6 | 32.3 | 31.6 | 30.6 | 29.2 |
| | sec⁻¹ | sec | | | | | | | | | |
| | 30 | KPa | 27.1 | 15.2 | 24.5 | 29.1 | 29.6 | 17.3 | 16.9 | 15.9 | 15.3 |
| | sec⁻¹ | sec | | | | | | | | | |
| | 100 | KPa | 10.8 | 6.51 | 10.0 | 11.6 | 11.8 | 7.7 | 7.3 | 6.8 | 6.4 |
| | sec⁻¹ | sec | | | | | | | | | |
| | 300 | KPa | 5.1 | 2.8 | 4.9 | 5.8 | 5.8 | 3.4 | 3.3 | 3.1 | 3.0 |
| | sec⁻¹ | sec | | | | | | | | | |
| Tensile | M₃₀₀ | MPa | 12.8 | 12.1 | 12.2 | 12.5 | 12.7 | 12.4 | 13.2 | 13.2 | 13.4 |
| properties | T_{B} | MPa | 28 | 29 | 27 | 28 | 28 | 29 | 30 | 30 | 30 |
| | E_{B} | % | 564 | 544 | 553 | 540 | 544 | 541 | 539 | 543 | 546 |
| Heat | M₃₀₀ | MPa | 16.7 | 15.0 | 15.7 | 15.9 | 16.3 | 16.1 | 16.1 | 16.0 | 15.9 |
| degradation | T_{B} | MPa | 23.2 | 22.8 | 22.3 | 24.2 | 25.7 | 23.1 | 26.3 | 26.5 | 26.2 |
| of tensile | E_{B} | % | 400 | 419 | 410 | 432 | 440 | 424 | 447 | 446 | 453 |
| properties | | | | | | | | | | | |
| Heat | tanδ | | 0.181 | 0.187 | 0.180 | 0.267 | 0.268 | 0.166 | 0.164 | 0.162 | 0.162 |
| buildup | 20° C. | | | | | | | | | | |
| | tanδ | | 0.162 | 0.166 | 0.160 | 0.222 | 0.218 | 0.143 | 0.141 | 0.140 | 0.138 |
| | 40° C. | | | | | | | | | | |
| | tanδ | | 0.143 | 0.147 | 0.138 | 0.175 | 0.174 | 0.135 | 0.133 | 0.130 | 0.129 |
| | 60° C. | | | | | | | | | | |

Note:
ND: Not detected.

Next, the rubber properties of the natural rubbers of Examples 1 to 3 and Comparative Examples 1 to 6 were compared. In each of the formulations shown in Table II, the ingredients other than the vulcanization accelerator and sulfur were mixed in a 1.7 liter Banbury mixer for 5 minutes. The mixture was discharged when reaching 140° C. to obtain a master batch. The vulcanization accelerator and sulfur were added to the master batch by an 8-inch open roll to obtain a rubber composition.

TABLE II

| | Parts by |
|---|---|
| Name of material | weight |
| Natural rubber | 100 |
| HAF grade carbon black (Shoblack N339, | 50 |
| Showa Cabot) | |
| Zinc oxide (Zinc Oxide No. 3, Seido | 3 |
| Chemical Industrial) | |
| Stearic acid (Beads Stearic Acid YR, NOF | 2 |
| Corporation) | |
| Aromatic oil (Extract No. 4S, Showa Shell | 5 |
| Oil) | |
| Sulfur (Gold Flower brand sulfur powder, | 2 |
| Tsurumi Chemical) | |
| Vulcanization accelerator (Noccelar NS-F, | 1 |
| Ouchi Shinko Chemical) | |

Next, the resultant rubber composition was measured for viscosity, was vulcanized in a 15×15×0.2 cm mold at 150° C. for 30 minutes to obtain vulcanized rubber sheet, then was measured for the other rubber properties by the test methods shown below. The results are shown in Table I.

Viscosity: measured by shear viscosity using Monsanto processability tester (made by Monsanto) with an orifice (diameter 1.5 mm, L/D=1) and a temperature of 120° C.

300% modulus (MPa): measured according to JIS K-6251 (JIS No. 3 dumbbell)

Tensile strength at break: measured according to JIS K-6251 (JIS No. 3 dumbbell)

Elongation at break: measured according to JIS K-6251 (JIS No. 3 dumbbell)

tan δ: measured using viscoelasticity spectrometer made by Toyo Seiki Seisakusho under conditions of strain of 10±2% and frequency of 20 Hz at 20° C., 40° C. and 60° C.

Note that the physical properties after heat aging in a gear oven (80° C.×168 hours) were measured in the same way and are shown in Table I.

Examples 1, 2, and 3 using natural rubber produced from latex treated according to Preparation Examples 1, 2 and 3 and Comparative Example 6 using latex treated also according to Preparation Example 1 are reduced in content of metals such as magnesium. It was learned that, at the shear speeds where the viscosities were measured (10 sec⁻¹ to 300 sec⁻¹), the metal contents were greatly decreased and the processability was improved, compared with Comparative Example 1 (RSS#3), Comparative Example 3 (STR20) and Comparative Examples 4 and 5 (using untreated latex). Further, it was learned that the heat buildups were low as shown in the results of low tan δ, which is the indicator of the heat buildup, and were low in heat generation at the time of use (time of deformation) as a rubber product. Further, it is learned that Examples 1, 2 and 3 using the pulse combustion method as the drying method have little change in tensile characteristics even after aging and are high in rate of maintenance of initial modulus (M₃₀₀), tensile strength (T_{B}), and elongation (E_{B}). Note that Comparative Example 2 (SMR-L) had a viscosity of the same level as the Examples, but was inferior to Examples 1, 2 and 3 in terms of tensile properties and heat buildup.

### Examples 4 to 5 and Standard Example 1 and Comparative Examples 1 to 6

### Example 4

### Preparation Example 4

### Production Method of Natural Rubber Used in Example 4

(1) Treatment of Latex

0.5% by weight of ammonium hydrogen phosphate was added to untreated field latex (made in Thailand, ammonia concentration=1.0% by weight, solid content concentration=about 30% by weight), then the mixture was gently stirred at 37° C. for 70 hours. The mixture was allowed to stand for a while, then the resultant precipitate was removed and the remainder was centrifugally separated by a centrifugal separator at 12000 rpm for 30 minutes. Approximately 0.1% by weight of a surfactant (sodium dodecyl sulfate) was added to the resultant cream-like substance which was then dispersed in distilled water to give a DRC (Dry Rubber Content) of about 60%, then 0.15% by weight of hydroxylamine sulfate was added.

(2) Drying of Latex

The treated latex obtained above was dried using a pulse shock wave dryer (Hypalcon made by Paltec) under conditions of a frequency of 1000 Hz and a temperature of 60° C.

### Example 5

### Preparation Example 5

### Production Method of Natural Rubber Used in Example 5

The same procedure as in Example 4 was performed for (25 the treatment of the latex and drying of the latex, except that semicarbazide was used in an amount of 0.15% by weight as a constant viscosity, agent.

Next, the rubber properties of the natural rubbers of Examples 4 and 5 and Comparative Examples 1 to 6 and Standard Example 1 (same as Example 1) were compared. In each of the formulations shown in Table II, the ingredients other than the vulcanization accelerator and sulfur were mixed in a 1.7 liter Banbury mixer for 5 minutes. The mixture was discharged when reaching 140° C. to obtain a master batch. The vulcanization accelerator and sulfur were added to the master batch by an 8-inch open roll to obtain a rubber composition.

Next, the physical properties of the resultant rubber compositions were measured by the following methods. The results are shown in Table IV.

Raw and Compound Mooney viscosity: Found according to JIS K6300 using L-shaped rotor, preheating at 100° C. for 1 minute, then starting rotation of rotor and measuring viscosity after 4 minutes.

Aged Mooney viscosity: Measured under above conditions after accelerated aging of raw rubber at 60° C. for 24 hours.

TABLE III

| | | | | | Comp. | | Standard | | |
|---|---|---|---|---|---|---|---|---|---|
| | | | | Comp. | Ex. 5 | Comp. | Ex. 1 | Ex. 4 | Ex. 5 |
| | | | | Ex. 4 | Ordinary | Ex. 6 | Treated | Treated | Treated |
| | Comp. | Comp. | Comp. | Ordinary | latex pulse | Treated | latex pulse | latex pulse | latex pulse |
| | Ex. 1 | Ex. 2 | Ex. 3 | latex oven | combustion | latex oven | combustion | combustion | combustion |
| | RSS#3 | SMR-L | STR-20 | drying | drying | drying | drying | drying | drying |
| Raw rubber Mooney | 94 | 100 | 92 | 86 | 78 | 79 | 73 | 72 | 73 |
| viscosity | | | | | | | | | |
| Mooney viscosity | 96 | 103 | 93 | 91 | 82 | 83 | 79 | 73 | 73 |
| after aging | | | | | | | | | |
| Compound Mooney | 65 | 63 | 62 | 76 | 70 | 71 | 66 | 64 | 63 |
| viscosity | | | | | | | | | |

As clear from the results of Table III, Examples 4 and 5 according to the present invention can give rubber compositions which are lower in Mooney viscosity and superior in processability and further have less of the increase in Mooney viscosity after aging compared with Comparative Examples 1 to 6.

### INDUSTRIAL APPLICABILITY

According to the present invention, natural rubber latex was treated by adding a water-soluble ammonium salt such as ammonium hydrogen phosphate to decrease the metal content, then the treated latex, directly or after the addition of a constant viscosity agent, was dried to solid rubber by the pulse drying method to obtain natural rubber having superior mechanical properties, low viscosity and easy workability. This natural rubber can be used for various rubber products, tires, belt conveyors, earthquake-proofing supports, and other various industrial use rubber products.

1. A method for producing a low viscosity natural rubber comprising the steps of:
treating a natural rubber latex with a water-soluble ammonium salt to decrease a metal content in the natural rubber latex; and
spraying the treated natural rubber latex in a pulse wave atmosphere for drying to obtain the solid rubber.

2. A method for producing a low viscosity natural rubber as claimed in claim 1, wherein said metal is a multivalent metal.

3. A method for producing a low viscosity natural rubber as claimed in claim 2, wherein said multivalent metal is magnesium.

4. A method for producing a low viscosity natural rubber as claimed in claim 1, wherein said ammonium salt is a bivalent ammonium salt.

5. A method for producing a low viscosity natural rubber as claimed in claim 1, wherein a constant viscosity agent is added, in advance, to the natural rubber latex to be dried by spraying into the pulse wave atmosphere.

6. A method for producing a low viscosity natural rubber as claimed in claim 5, wherein an addition amount of said constant viscosity agent is 0.005 to 3.0% by weight, based upon the solid content weight of the natural rubber.

7. A method of producing a low viscosity natural rubber as claimed in claim 5, wherein said constant viscosity agent is at least one agent selected from the group consisting of hydroxylamine sulfate, hydroxylamine, semicarbazide, dimedone, and a hydrazide compound.

8. A low viscosity natural rubber producible by the method according to claim 1 having a reduced magnesium content of 0.02% by weight or less based on the dried latex solid content.

9. A rubber composition comprising the low viscosity natural rubber according to claim 8.

10. A method for producing a low viscosity natural rubber as claimed in claim 2, wherein said ammonium salt is a bivalent ammonium salt.

11. A method for producing a low viscosity natural rubber as claimed in claim 3, wherein said ammonium salt is a bivalent ammonium salt.

12. A method for producing a low viscosity natural rubber as claimed in claim 2, wherein a constant viscosity agent is added, in advance, to the natural rubber latex to be dried by spraying into the pulse wave atmosphere.

13. A method for producing a low viscosity natural rubber as claimed in claim 3, wherein a constant viscosity agent is added, in advance, to the natural rubber latex to be dried by spraying into the pulse wave atmosphere.

14. A method for producing a low viscosity natural rubber as claimed in claim 4, wherein a constant viscosity agent is added, in advance, to the natural rubber latex to be dried by spraying into the pulse wave atmosphere.

15. A method of producing a low viscosity natural rubber as claimed in claim 6, wherein said constant viscosity agent is at least one agent selected from the group consisting of hydroxylamine sulfate, hydroxylamine, semicarbazide, dimedone, and a hydrazide compound.

16. A method for producing a low viscosity natural rubber as claimed in claim 12, wherein an addition amount of said constant viscosity agent is 0.005 to 3.0% by weight, based upon the solid content weight of the natural rubber.

17. A method for producing a low viscosity natural rubber as claimed in claim 13, wherein an addition amount of said constant viscosity agent is 0.005 to 3.0% by weight, based upon the solid content weight of the natural rubber.

18. A method for producing a low viscosity natural rubber as claimed in claim 14, wherein an addition amount of said constant viscosity agent is 0.005 to 3.0% by weight, based upon the solid content weight of the natural rubber.

19. A low viscosity natural rubber producible by the method according to claim 2 having a reduced magnesium content of 0.02% by weight or less based on the dried latex solid content.

20. A low viscosity natural rubber producible by the method according to claim 3 having a reduced magnesium content of 0.02% by weight or less based on the dried latex solid content.
